(19) United States
(12) Patent Application Publication
(10) Pub. No.: US 2013/0185780 A1
(43) Pub. Date: Jul. 18, 2013

(54) COMPUTER IMPLEMENTED METHOD AND SYSTEM FOR GENERATING A ONE TIME PASSWORD

(71) Applicants: Vijayaraghavan Varadharajan, Salem (IN); Sivakumar Kuppusamy, Coimbatore (IN); Kanika Pasricha, New Delhi (IN); Rajarathnam Nallusamy, Thuraiyur Taluk (IN)

(72) Inventors: Vijayaraghavan Varadharajan, Salem (IN); Sivakumar Kuppusamy, Coimbatore (IN); Kanika Pasricha, New Delhi (IN); Rajarathnam Nallusamy, Thuraiyur Taluk (IN)

(73) Assignee: INFOSYS LIMITED, Bangalore (IN)

(21) Appl. No.: 13/531,683

(22) Filed: Jun. 25, 2012

(30) Foreign Application Priority Data
Jan. 12, 2012 (IN) 147/CHE/2012

(51) Int. Cl. G06F 21/00

(52) U.S. Cl. 726/6

(57) ABSTRACT

This technology provides methods, non-transitory computer readable medium and apparatuses that generate a OneTime Password (OTP) such that no hardware token is used. The technology uses some functions and parameters generated and transmitted to the client machine, by the server. The server generates a token for each session, cyclic groups G1 and G2 of elements and sends this to client machine. The client generates a first OTP using a predefined function on the token and the hash value of user password, such that retrieving the hash value of the password from the first OTP is a discrete log problem. A second OTP is generated using a bilinear mapping on the first OTP, and an element of G1, such that generating first OTP from second OTP is a bilinear inverse problem.

This application claims the benefit of Indian Patent Application Filing No. 147/CHE/2012, filed Jan. 13, 2012, which is hereby incorporated by reference in its entirety.

### FIELD

The present invention relates to methods, non-transitory computer readable medium and apparatuses that generate a One Time Password (OTP). More specifically, it relates to using at least one non-degenerate function to generate an OTP without using any hardware tokens and securing the generated OTP by discrete log problem and bilinear inverse problem.

### BACKGROUND

A One Time Password (OTP) is a password used for only one session or transaction. After the expiry of the session, the OTP also expires or gets timed out after a preset time. The use of OTP provides user security. Even if an OTP is hacked, it cannot be used after expiry of the session.

There exist various methods for generating an OTP. Typically, they are related to using the original user password and generating a random number using some function. Most of these processes also involve using hardware tokens. The same process is also applied at the server. A user is provided with the generated OTP at the client machine. The user enters the OTP, which goes to the server for authentication. The server, having done the same calculation over the user password, authenticates the user.

Any unauthorized access to the OTP may not be useful, because of the time for which the OTP stays valid. If the OTP is retrieved, and the function used to create the OTP is also available, reverse engineering is required to get the user password. Most of such functions may not be very strong. Hence, an unauthorized user can reverse engineer to get the password.

Accordingly, a stronger system is needed to generate the OTP, which uses one or more stronger functions that require a big turnaround time for reverse engineering.

### SUMMARY

A method for generating a one time password (OTP) comprising installing a DLL file at a client, capturing user credentials at the client. The user credentials comprise a user name and a password (P), receiving a token (s) and a plurality of parameters from the server. A first OTP (Q1) is generated using the installed DLL file, the DLL file using the token (s) and a hash value (H) of the password. A second OTP (Q2) is generated using the installed DLL file. The DLL file uses the first OTP (Q1) and an element (N) belonging to one of the plurality of parameters. One of the first OTP and the second OTP is used for user authentication, the second OTP not being generated when the first OTP is used for user authentication.

A method for generating a one time password (OTP) in a handheld device which comprises installing a client application at a handheld device. User credentials are captured at the client handheld device, wherein the user credentials comprise a user name and a password (P). A token (s) and a plurality of parameters are received from a server. A first OTP (Q1) is generated using the installed client application, the client application using the token (s) and a hash value (H) of the password. A second OTP (Q2) is generated using the installed client application. The client application uses the first OTP and an element (N) belonging to one of the plurality of parameters. One of the first OTP and the second OTP being used for user authentication, the second OTP not being generated when the first OTP is used for user authentication.

The method for generating a one time password (OTP), wherein the method comprises generating a first and a second cyclic group (G1, G2) of elements at a server, the first and second group being of a predefined order, capturing user credentials, wherein the user credentials comprise a user name and a password (P). A token (s) for one session, and the first and second group of elements (G1 and G2) are received from the server. A predetermined function is selected for generating a first OTP (Q1) from the token (s) and a hash value (H) of the password, Q1=sH the first OTP (Q1) and the token being an element of the first group (G1) and generating H from Q1 being a discrete log problem. A bilinear mapping ( ) is selected for generating a second OTP (Q2) using the first OTP (Q1) and an element (N) of G1, the second OTP being an element of the second group (G2) and generating Q1 back from Q2 being a bilinear inverse problem. One of the first OTP and the second OTP is used for user authentication, the second OTP not being generated when the first OTP is used for user authentication.

A One Time Password (OTP) generation apparatus comprising a memory coupled to one or more processors which are configured to execute programmed instructions stored in the memory comprising installing a DLL file at a client and capturing user credentials at the client, wherein the user credentials comprise a user name and a password (P). A token (s) and a plurality of parameters are received from the server. A first OTP (Q1) is generated using the installed DLL file, the DLL file using the token (s) and a hash value (H) of the password, the token (s) being made public. A second OTP (Q2) is generated using the installed DLL file, the DLL file using the first OTP (Q1) and an element (N) of the cyclic group G1. One of the first OTP or the second OTP being used for user authentication, the second OTP not being generated when the first OTP is used for user authentication.

A One Time Password (OTP) generation apparatus comprising a memory coupled to one or more processors which are configured to execute programmed instructions stored in the memory comprises installing a client application at a client handheld device and capturing user credentials at the client handheld, wherein the user credentials comprise a user name and a password (P). A token (s) and a plurality of parameters are received from a server. A first OTP (Q1) is generated using the installed client application, the client application using the token (s) and a hash value (H) of the password. A second OTP (Q2) is generated using the installed client application, the client application using the first OTP and an element (N) of one of the plurality of parameters. One of the first OTP and the second OTP being used for user authentication, the second OTP not being generated when the first OTP is used for user authentication.

A non-transitory computer readable medium having stored thereon instructions for generating a One Time Password (OTP) comprising machine executable code which when executed by at least one processor, causes the processor to perform steps including installing a DLL file at a client from the server and capturing user credentials at the client, wherein the user credentials comprise a user name and a password (P). A token (s) and a plurality of parameters are received from the server. A first OTP (Q1) is generated using the installed DLL file, the DLL file using the token (s) and a hash value (H) of the password. A second OTP (Q2) is generated using the installed DLL file, the DLL file using the first OTP (Q1) and an element (N) of one of the plurality of parameters. One of the first OTP and the second OTP being used for user authentication, the second OTP not being generated when the first OTP is used for user authentication.

A non-transitory computer readable medium having stored thereon instructions for generating a One Time Password (OTP) comprising machine executable code which when executed by at least one processor, causes the processor to perform steps including installing a client application at a client handheld device and capturing user credentials at the client machine, wherein the user credentials comprise a user name and a password (P). A token (s) and a plurality of parameters are received from the server. A first OTP (Q1) is generated using the installed DLL file, the DLL file using the token (s) and a hash value (H) of the password. A second OTP (Q2) is generated using the installed DLL file, the DLL file using the first OTP (Q1) and an element (N) of one of the plurality of parameters; one of the first OTP and the second OTP being used for user authentication, the second OTP not being generated when the first OTP is used for user authentication.

### BRIEF DESCRIPTION OF DRAWINGS

FIG. 1 is a flowchart describing in brief the process of an example of the instant invention;

FIG. 2 is an example of the procedure of the instant invention;

FIG. 3 is a block diagram of an example of a system of the instant invention; and

FIG. 4 describes the basic computer program structure where an example of the instant invention can be implemented.

### DETAILED DESCRIPTION

The following description is full and informative description of the best method and system presently contemplated for carrying out the present invention, which is known to the inventors at the time of filing the patent application. Of course, many modifications and adaptations will be apparent to those skilled in the relevant arts in view of the following description, in view of the accompanying drawings and the appended claims. While the system and method described herein are provided with a certain degree of specificity, the present technique may be implemented with either greater or lesser specificity, depending on the needs of the client. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

The following description is presented to enable a person of ordinary skill in the art to make and use the invention and is provided in the context of the requirement for obtaining a patent. The present description is the best presently contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

The present invention provides a method for generating a one-time password (OTP) such that the OTP is strong and cannot be processed to get the user password, even if the OTP is accessed through unauthorized means. For this purpose, an example of the present invention uses discrete exponentiation functions and/or bilinear mapping to generate the OTP. The user password is used as one of the parameter to be used in the above functions to generate the OTPs. Additional parameters may also be used in an example, as explained in detail in the following paragraphs.

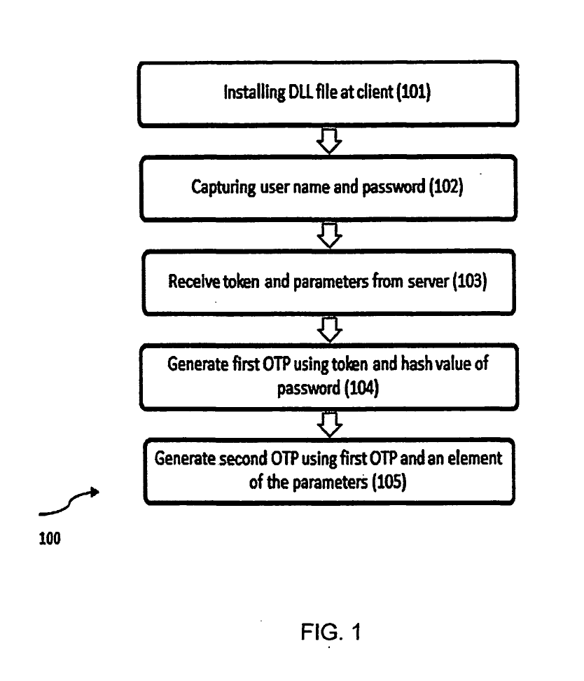

FIG. 1 is a flowchart describing in brief the process of an example of the instant invention. In one embodiment of the present invention, a client machine uses a DLL file that has all processes for generating the OTP. The server sends a DLL file to be installed at the user machine (101). It should be noted that these are inbuilt functions within the server. The user enters the username and password for authentication (102). This user password is not transmitted to the server. Instead, an OTP to be sent to the server is created so that the user password cannot be accessed by unauthorized users. For creating the OTP, the server sends one or more parameters to the client machine and the functions stored in the DLL use these parameters (103). In an embodiment of the present invention, only one OTP is generated and transmitted to the server (104). In another embodiment, a second OTP is generated using the first OTP, and only the second OTP is transmitted to the server (105). It should be understood that the functions used for generating the OTP are such that even if an unauthorized user is able to access the OTP and the functions used, the process to get the user password will have a very big turnaround time.

In an example, by using the inbuilt functions, the server generates a first and/or second OTP using the password stored with it. Thus the user is authenticated.

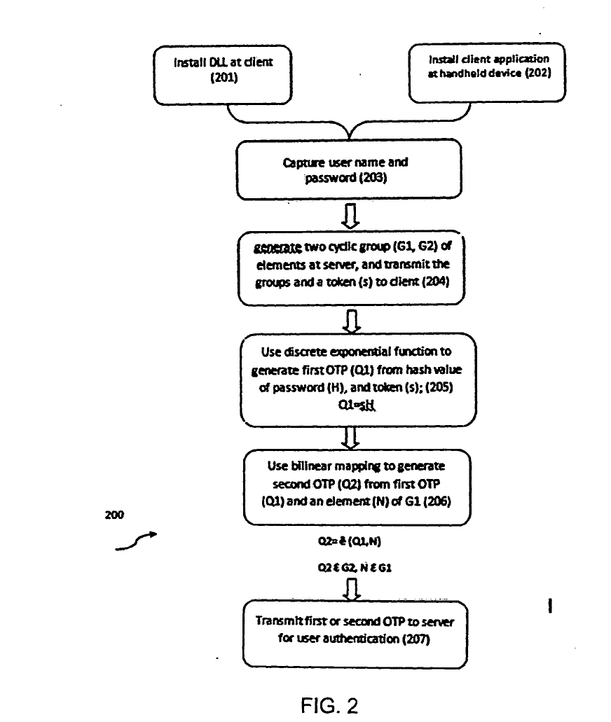

FIG. 2 describes an example for the implementation of the process of the invention. The means of implementation of the process are first provided in the machine where the user logs in. In one embodiment, the process is implemented at a client machine. Such a client machine may be a desktop computer, a laptop computer, a kiosk, an ATM and the like. In another embodiment, the process is implemented at a handheld device. Such a handheld device may include mobile device, pager device, PDA, tablet, and other such handheld electronic devices.

In an embodiment, a DLL file is installed at the client machine. The DLL file includes all functionalities required for the working of the present invention. In another embodiment, an application configured for handheld electronic device is installed at the client handheld electronic device [earlier, you have talked about client machines and handheld devices.]. This application has the various functionalities required for the working of the present invention.

For the generation of the OTP, in one embodiment, the user provides his login credentials at the client machine or the client handheld device (203). In an example, the user credentials include username and user password.

In an example, the invention uses a set of parameters and functions to be applied to the user password. In an embodiment, one set of such parameters includes two cyclic groups, G1 and G2, of elements. These groups are of order ‘n’. In an embodiment, these groups are generated at the server. The server also generates a token ‘s’ for each session. These parameters are then transmitted to the client, a copy being saved at the server (204).

The above parameters are used to generate the OTP. In an embodiment, the present invention generates two OTPs using two different functions. For the first OTP(Q1), in one embodiment, the invention uses a predefined function (205). The function is applied over hash value of the user password (H), and the token (s), Q1=sH. It should be noted that since the token (s) is different for every session, Q1 is different for each session. Hence, it is a ‘One Time Password’. For the next user session, the server creates a new token (s), and hence Q1 is also different.

The first OTP (Q1) and the token (s) are the elements of the cyclic group G1. In one embodiment, the first OTP (Q1) is sent to the server for user authentication. In an example, discrete exponentiation function is used to generate the first OTP.

Even if the first OTP Q1 and the token (s) are retrieved through unauthorized access, retrieving the hash value of the user password is a discrete log problem.

The server has the user password previously stored in its database when it was generated. The server is also aware of the function used to generate the first OTP. The server retrieves the token (s) for the particular session and generates an OTP using the same function over the hash value of the password and the token. Then, the OTP received from the client and the OTP generated at the server are compared. If they match, the user is authenticated.

In another embodiment, a second OTP (Q2) is generated using the first OTP Q1, and a bilinear mapping ( ) (206),

Q2=ê(Q1,N)

Q2εG2,NεG1

The bilinear mapping uses an element (N) of G1, and Q1. The second OTP Q2 is an element of the cyclic group G2.

As mentioned above, since Q1 is different for every session, accordingly Q2 also differs for each session, and is hence a ‘One Time Password’.

The second OTP Q2 is transmitted to the server (207). If Q2 is retrieved by unauthorized access, reverse calculating the bilinear mapping to get Q1 is a bilinear inverse problem. And consequently, generating the hash value of the user password from Q1 is a discrete log problem. Further, retrieving the user password from the hash value of the user password has a huge turnaround time.

Therefore, according to the present invention, Q1 and Q2 are very strong OTPs, and the user password is very strongly protected.

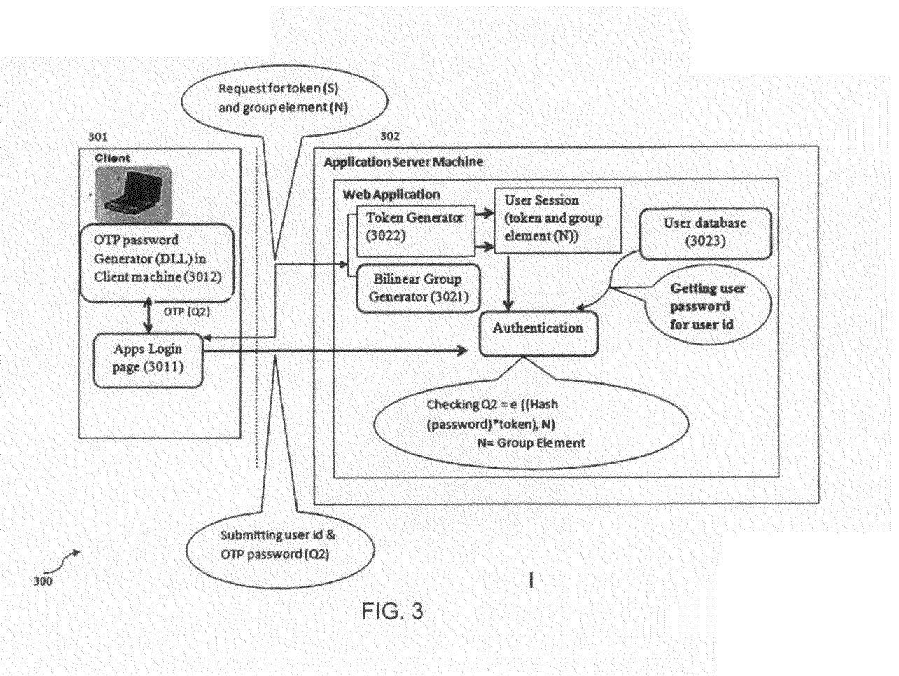

FIG. 3 provides a block diagram 300 of the system used for implementing an example of the invention.

The block diagram 300 shows a client 301, and a server 302, which include components for performing the various procedures of the instant invention. The client 301 has an Apps Login page 3011, where a user provides his credentials, i.e. username and password. The block diagram also shows component 3012 comprising the DLL file installed at the client, by the server 302. The DLL file has the functions stored to generate the OTPs Q1 and Q2. In an example, such functions include discrete exponential function and bilinear mapping respectively.

The server 302 has components 3021 and 3022 to generate the required parameters. 3021 is a bilinear group generator, which generates the cyclic groups G1 and G2, of a predefined order. These are transmitted to the client. 3022 is a token generator that generates the token (s) for each session. The token is also transmitted to the server. The server also has a copy of these parameters. Since the token (s) is different for each session, Q1 and Q2 are also different.

The user password had been previously stored at the server database (3023) when it was created by the user. The server also generates a number N such that N is an element of cyclic group G1, and sends it to the client. The server retrieves the user password and token for the particular session, and uses the parameters (G1, G2, N and s) to generate the OTPs Q1 and Q2 as explained earlier. The functions for generating these OTP are available to the server.

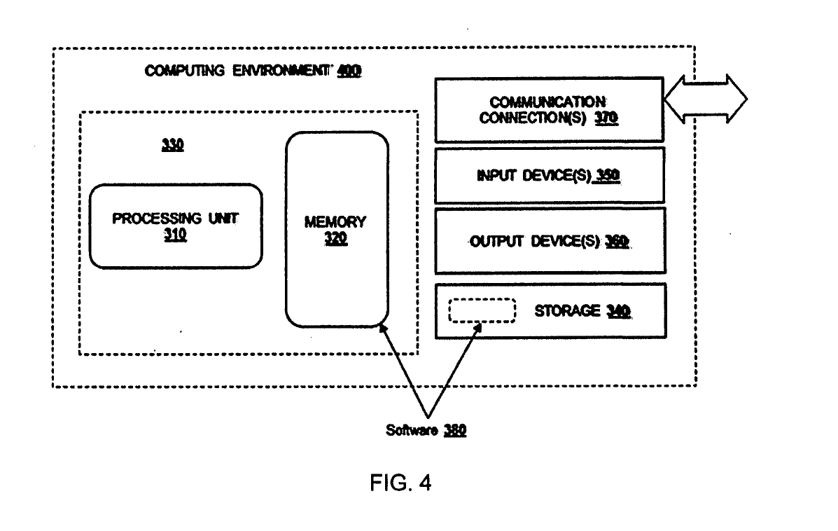

FIG. 4 is a system illustrating a generalized computer network arrangement, in one embodiment of the present technique.

### Exemplary Computing Environment

One or more of the above-described techniques can be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 310 and memory 320. In FIG. 4, this most basic configuration 330 is included within a dashed line. The processing unit 310 executes computer-executable instructions and may be a real or a virtual processor. In a multi-processing system, multiple processing units execute computer-executable instructions to increase processing power. The memory 320 may be volatile memory (e.g., registers, cache, RAM), non-volatile memory (e.g., ROM, EEPROM, flash memory, etc.), or some combination of the two. In some embodiments, the memory 320 stores software 380 implementing described techniques.

A computing environment may have additional features. For example, the computing environment 400 includes storage 340, one or more input devices 350, one or more output devices 360, and one or more communication connections 370. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 340 may be removable or non-removable, and includes magnetic disks, magnetic tapes or cassettes, CD-ROMs, CD-RWs, DVDs, or any other medium which can be used to store information and which can be accessed within the computing environment 400. In some embodiments, the storage 340 stores instructions for the software 380.

The input device(s) 350 may be a touch input device such as a keyboard, mouse, pen, trackball, touch screen, or game controller, a voice input device, a scanning device, a digital camera, or another device that provides input to the computing environment 400. The output device(s) 360 may be a display, printer, speaker, or another device that provides output from the computing environment 400.

The communication connection(s) 370 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 400, computer-readable media include memory 320, storage 340, communication media, and combinations of any of the above.

While the foregoing has described certain embodiments and the best mode of practicing the invention, it is understood that various implementations, modifications and examples of the subject matter disclosed herein may be made. It is intended by the following claims to cover the various implementations, modifications, and variations that may fall within the scope of the subject matter described.

What is claimed is:

1. A method for generating a onetime password (OTP), the method comprises:
installing a DLL file at a client from the server;
capturing user credentials at the client, wherein the user credentials comprise a user name and a password (P);
receiving a token (s) for one session, and a plurality of parameters from the server;
generating a first OTP (Q1) using the installed DLL file, the DLL file using the token (s) and a hash value (H) of the password; and
generating a second OTP (Q2) using the installed DLL file, the DLL file using the first OTP (Q1) and an element (N) of one of the plurality of parameters;
one of the first OTP and the second OTP being used for user authentication, the second OTP not being generated when the first OTP is used for user authentication.

2. The method as claimed in claim 1, wherein the token (s) is generated by the server for a user session.

3. The method as claimed in claim 1, wherein the plurality of parameters comprises a first and a second cyclic group (G1 and G2) of elements, said first and second groups being of a predefined order (n).

4. The method as claimed in claim 3, wherein the first OTP (Q1) is generated using a predefined function, Q1=sH, the token (s) and Q1 being an element of the first group (G1), and generating H from Q1 being a discrete log problem.

5. The method as claimed in claim 3, wherein the second OTP (Q2) is generated using a bilinear mapping ( ), the element (N) being an element of the first group G1, and the second OTP (Q2) being an element of the second group (G2),
Q2=ê(Q1,N)
Q2εG2,NεG1.

6. A method for generating a One Time Password (OTP) in a handheld device, the method comprises:
installing a client application at a client handheld device;
capturing user credentials at the client handheld, wherein the user credentials comprise a user name and a password (P);
receiving a token (s) for one session, and a plurality of parameters from a server;
generating a first OTP (Q1) using the installed client application, the client application using the token (s) and a hash value (H) of the password; and
generating a second OTP (Q2) using the installed client application, the client application using the first OTP and an element (N) of one of the plurality of parameters;
one of the first OTP and the second OTP being used for user authentication, the second OTP not being generated when the first OTP is used for user authentication.

7. The method as claimed in claim 6, wherein the token (s) is generated by the server for a user session.

8. The method as claimed in claim 6, wherein the plurality of parameters comprises a first and a second cyclic group (G1 and G2) of elements, said first and second groups being of a predefined order (n).

9. The method as claimed in claim 8, wherein the first OTP (Q1) is generated using a predefined function Q1=sH, the token (s) and Q1 being an element of the first group (G1), and generating H from Q1 being a discrete log problem.

10. The method as claimed in claim 8, wherein the second OTP (Q2) is generated using a bilinear mapping ( ), the element (N) being an element of the first group G1, and the second OTP (Q2) being an element of the second group (G2),
Q2=ê(Q1,N)
Q2εG2,NεG1.

11. A method for generating a One Time Password (OTP), the method comprises:
generating a first and a second cyclic group (G1, G2) of elements at a server, the first and second group being of a predefined order;
capturing user credentials, wherein the user credentials comprise a user name and a password (P);
receiving a token (s) for one session, and the first and second group (G1 and G2) of elements from the server;
selecting a predetermined function for generating a first OTP (Q1) from the token (s) and a hash value (H) of the password, Q1=sH the first OTP (Q1) and the token (s) being an element of the first group (G1) and generating H from Q1 being a discrete Log problem;
selecting a bilinear mapping ( ) for generating a second OTP (Q2) using the first OTP (Q1) and an element (N) of G1,
Q2=ê(Q1,N)
Q2εG2,NεG1
the second OTP being an element of the second group (G2);
wherein one of the first OTP and the second OTP is used for user authentication, the second OTP not being generated when the first OTP is used for user authentication.

12. The method as claimed in claim 11, wherein a DLL file is installed at the client machine to generate the first and the second OTP.

13. The method as claimed in claim 11, wherein a client application is installed at a client handheld device to generate the first and the second OTP.

14. A One Time Password (OTP) generation apparatus, the apparatus comprising:
one or more processors;
a memory coupled to the one or more processors which are configured to execute programmed instructions stored in the memory comprising:
installing a DLL file at a client from the server;
capturing user credentials at the client, wherein the user credentials comprise a user name and a password (P);
receiving a token (s) and a plurality of parameters from the server;
generating a first OTP (Q1) using the installed DLL file, the DLL file using the token (s) and a hash value (H) of the password; and
generating a second OTP (Q2) using the installed DLL file, the DLL file using the first OTP (Q1) and an element (N) of one of the plurality of parameters;
one of the first OTP and the second OTP being used for user authentication, the second OTP not being generated when the first OTP is used for user authentication.

15. The apparatus as claimed in claim 14, wherein the token (s) is generated by the server for a user session.

16. The apparatus as claimed in claim 14, wherein the plurality of parameters comprises a first and a second cyclic group (G1 and G2) of elements, said first and second groups being of a predefined order (n).

17. The apparatus as claimed in claim 16, wherein the one or more processors is further configured to execute programmed instructions stored in the memory for the generating the first OTP further comprises generating the first OTP (Q1) using a predefined function Q1=sH, the token (s) and Q1 being an element of the first group (G1), and generating H from Q1 being a Discretelog problem.

18. The apparatus as claimed in claim 16, wherein the one or more processors is further configured to execute programmed instructions stored in the memory for the second generating the second OTP further comprises generating the second OTP (Q2) using a bilinear mapping ( ), the element (N) being an element of the first group G1, and the second OTP (Q2) being an element of the second group (G2),
Q2=ê(Q1,N)
Q2εG2,NεG1.

19. A One Time Password (OTP) generation apparatus, the apparatus comprising:
one or more processors;
a memory coupled to the one or more processors which are configured to execute programmed instructions stored in the memory comprising:
installing a client application at a client handheld device;
capturing user credentials at the client handheld, wherein the user credentials comprise a user name and a password (P);
receiving a token (s) and a plurality of parameters from a server;
generating a first OTP (Q1) using the installed client application, the client application using the token (s) and a hash value (H) of the password; and
generating a second OTP (Q2) using the installed client application, the client application using the first OTP and an element (N) of one of the plurality of parameters;
one of the first OTP and the second OTP being used for user authentication, the second OTP not being generated when the first OTP is used for user authentication.

20. A non-transitory computer readable medium having stored thereon instructions for generating a One Time Password (OTP) comprising machine executable code which when executed by at least one processor, causes the processor to perform steps comprising:
installing a DLL file at a client from the server;
capturing user credentials at the client, wherein the user credentials comprise a user name and a password (P);
receiving a token (s) and a plurality of parameters from the server;
generating a first OTP (Q1) using the installed DLL file, the DLL file using the token (s) and a hash value (H) of the password; and
generating a second OTP (Q2) using the installed DLL file, the DLL file using the first OTP (Q1) and an element (N) of one of the plurality of parameters;
one of the first OTP and the second OTP being used for user authentication, the second OTP not being generated when the first OTP is used for user authentication.

21. A non-transitory computer readable medium having stored thereon instructions for generating a One Time Password (OTP) comprising machine executable code which when executed by at least one processor, causes the processor to perform steps comprising:
installing a client application at a client handheld device;
capturing user credentials at the client machine, wherein the user credentials comprise a user name and a password (P);
receiving a token (s) and a plurality of parameters from the server;
generating a first OTP (Q1) using the installed DLL file, the DLL file using the token (s) and a hash value (H) of the password; and
generating a second OTP (Q2) using the installed DLL file, the DLL file using the first OTP (Q1) and an element (N) of one of the plurality of parameters;
one of the first OTP and the second OTP being used for user authentication, the second OTP not being generated when the first OTP is used for user authentication.
